(19) United States
(12) Patent Application Publication
(10) Pub. No.: US 2006/0082841 A1
(43) Pub. Date: Apr. 20, 2006

(54) Imaging apparatus

(75) Inventors: Fumiyuki Shiratani, Sagamihara-shi (JP); Hiroyuki Minakata, Hachioji-shi (JP); Noriyuki Iyama, Hachioji-shi (JP); Nobuyuki Watanabe, Yokohama-shi (JP); Shinichi Mihara, Tama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/228,680

(22) Filed: Sep. 16, 2005

(30) Foreign Application Priority Data
Sep. 21, 2004 (JP) 2004-273747

(51) Int. Cl. H04N 1/04

(52) U.S. Cl. 358/474

(57) ABSTRACT

An imaging apparatus is disclosed. An imaging device acquires an object image as pixel data in accordance with photoelectric conversion. A readout region setting unit sets a region in which image data is to be read out from the imaging device. A readout unit reads out the image data from the readout region. An optimal position calculating unit calculates a position optimal for imaging according to the position and size of a readout region set by the readout region setting unit. An adjusting mechanism drives an imaging surface of the imaging device at the optimal position calculated by the optimal position calculating unit.

### CROSS-REFERENCE TO RELATED APPLICATIONS

This application is based upon and claims the benefit of priority from prior Japanese Patent Application No. 2004-273747, filed Sep. 21, 2004, the entire contents of which are incorporated herein by reference.

### BACKGROUND OF THE INVENTION

1. Field of the Invention

The present invention relates to an imaging apparatus.

2. Description of the Related Art

A method using an optical zoom and a method using an electronic zoom (digital zoom) are known to display a main object such as a person in a zoom-in manner. The optical zoom has an advantage that an object can be acquired as an image at a high resolution. In contrast, the electronic zoom can display an arbitrary region contained in an image by isolating it momentarily, and is advantageous in that it is more excellent than the optical zoom in view of an operating speed and power consumption.

A camera having a zoom mechanism is disclosed in Jpn. Pat. Appln. KOKAI Publication No. 5-19158, for example. In addition, Jpn. Pat. Appln. KOKAI Publication No. 8-160296 discloses a configuration in which an effective imaging surface of an imaging device is disposed outside of an optical axis in an image forming optical system and this effective imaging surface is tilted in a direction for bending an imaging surface of the image forming optical system.

### BRIEF SUMMARY OF THE INVENTION

According to a first aspect of the invention, there is provided an imaging apparatus comprising an imaging device which acquires an object image as pixel data in accordance with photoelectric conversion; a readout region setting unit which sets, from the imaging device, a region whose image data is read out; a readout unit which reads out image data from the readout region; an optimal position calculating unit which calculates an optimal position for imaging in response to a position and a size of the readout region set by the readout region setting unit; and an adjusting mechanism which drives an imaging surface of the imaging device at an optimal position calculated by the optimal position calculating unit.

According to a second aspect of the invention, there is provided an imaging apparatus according to the first aspect, wherein a total number of pixels for which readout is carried out by the readout unit is smaller than a total number of pixels configuring the imaging device.

According to a third aspect of the invention, there is provided an imaging apparatus according to the first aspect, having a total pixel number changing unit which changes a total number of pixels for which readout is carried out by the readout unit.

According to a fourth aspect of the invention, there is provided an imaging apparatus according to the first aspect, having a readout region changing unit which changes a size of the readout region.

According to a fifth aspect of the invention, there is provided an imaging apparatus according to the fourth aspect, wherein the readout region changing unit comprises a pixel mixed readout function of reading out a plurality of pixels configuring the imaging device in one clock.

According to a sixth aspect of the invention, there is provided an imaging apparatus according to the fourth aspect, wherein the readout region changing unit comprising a thinning-out readout function of reading out a plurality of pixels configuring the imaging device by thinning out the pixels.

According to a seventh aspect of the invention, there is provided an imaging apparatus according to the first aspect, including an imaging device shifting mechanism which shifts the imaging surface by shifting a position of the imaging device relevant to an optical system which forms an image on the imaging device.

According to an eighth aspect of the invention, there is provided an imaging apparatus according to the first aspect, including an optical element shifting mechanism which shifts the imaging surface by shifting an optical element which configures an optical system which forms an image on the imaging device.

According to a ninth aspect of the invention, there is provided an imaging apparatus according to the first aspect, further comprising an object tracking mechanism which tracks a main object, wherein the block readout unit carries out readout by referring to positional information on the object acquired by the object tracking mechanism.

According to a tenth aspect of the invention, there is provided an imaging apparatus comprising: an imaging device which acquires an object image as pixel data in accordance with photoelectric conversion; a region of interest setting unit which sets a region of interest which includes a main object in an image acquired by the imaging device; a readout region setting unit which sets a region in which image data is to be read out from the imaging device in response to the region of interest set by the region of interest setting unit; a readout unit which reads out image data from the readout region; a recording/display unit which records or displays the read out image data after converted to a mode suitable to an output; an optimal position calculating unit which calculates an optimal position which is optimal for imaging according to a position and a size of the readout region set by the readout region setting unit; and an adjusting mechanism which drives an imaging surface of the imaging device at the optimal position calculated by the optimal position calculating unit.

According to an eleventh aspect of the invention, there is provided an imaging apparatus according to the tenth aspect, wherein a total number of pixels for which readout is carried out by the readout unit is smaller than a total number of pixels configuring the imaging device.

According to a twelfth aspect of the invention, there is provided an imaging apparatus according to the tenth aspect, having a total pixel number changing unit which changes a total number of pixels for which readout is carried out by the readout unit.

According to a thirteenth aspect of the invention, there is provided an imaging apparatus according to the tenth aspect, having a readout region changing unit which changes a size of the readout region.

According to a fourteenth aspect of the invention, there is provided an imaging apparatus according to the thirteenth aspect, wherein the readout region changing unit comprises a pixel mixed readout function of reading out a plurality of pixels configuring the imaging device in one clock.

According to a fifteenth aspect of the invention, there is provided an imaging apparatus according to the thirteenth aspect, wherein the readout region changing unit comprising a thinning-out readout function of reading out a plurality of pixels configuring the imaging device by thinning out the pixels.

According to a sixteenth aspect of the invention, there is provided an imaging apparatus according to the tenth aspect, including an imaging device shift mechanism which shifts the imaging surface by shifting a position of the imaging device relevant to an optical system which forms an image on the imaging device.

According to a seventeenth aspect of the invention, there is provided an imaging apparatus according to the tenth aspect, including an optical element shifting mechanism which shifts the imaging surface by shifting an optical element which configures an optical system which forms an image on the imaging device.

According to an eighteenth aspect of the invention, there is provided an imaging apparatus according to the tenth aspect, further comprising an object tracking mechanism which tracks a main object, wherein the block readout unit carries out readout by referring to positional information on the object acquired by the object tracking mechanism.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing a configuration of an imaging apparatus according to the invention;

FIG. 2 is a flowchart showing an outline of an operation according to the invention;

FIGS. 3A to 3D are diagrams each showing tilt control of an imager 102 in accordance with the invention;

FIGS. 4A to 4F are diagrams each showing a variation of block readout in accordance with the invention;

FIG. 5 is a schematic diagram showing a configuration according to another embodiment of the invention;

FIG. 6 shows an example of readout by thinning out two from eight pixels in thinning-out readout;

FIG. 7 is a conceptual diagram of carrying out a distortion correcting process after thinning-out readout; and

FIGS. 8A and 8B are diagrams each showing an example in a case where a readout region is and is not off-center of an optical axis.

### DETAILED DESCRIPTION OF THE INVENTION

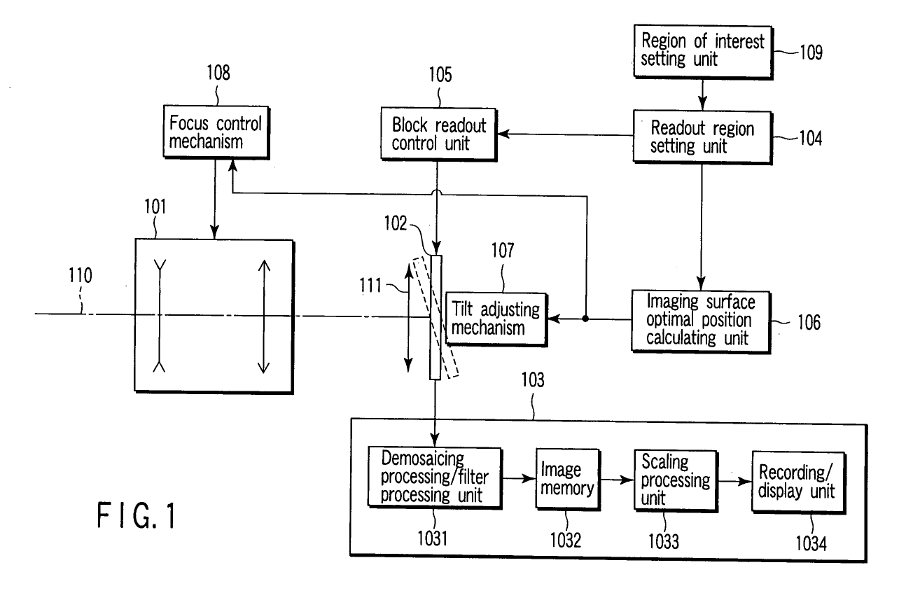

Hereinafter, an embodiment of the present invention will be described with reference to FIG. 1. FIG. 1 shows an outline of an imaging apparatus according to the invention. An object image is formed on an imager (imaging device) 102 by an optical system 101. The imager 102 acquires an object image as image data by photoelectric conversion. The image data acquired by the imager 102 is read out on a block-by block-basis by an image converting/recording/display unit 103, and then, is converted, recorded and displayed for an image oriented to an output image. That is, first, a demosaicing (full coloring) process and a filter process are carried out with respect to image data by a demosaicing processing/filter processing unit 1031, and image data after processed is temporarily maintained as frame data in an image memory 1032. A scaling processing unit 1033 carries out a predetermined scaling process with respect to the image data contained in the image memory 1032. A recording/display unit 1034 records and displays the image data.

A region of interest setting unit 109 is provided as a unit for manually or automatically setting a region of interest in the vicinity of a main object. A readout region setting unit 104 sets a region in which image data is to be read out from the imager 102 in response to the set region of interest. A block readout control unit 105 controls readout of image data based on the set readout region. An imaging surface optimal position calculating unit 106 corrects curvature of field and calculates an imaging surface position such that focus and geometrical distortion become optimal in response to a position and a size of the set readout region. A tilt adjusting mechanism 107 and a focus control mechanism 108 carry out adjustment of an imaging surface so that an imaging surface moves to the calculated imaging surface position.

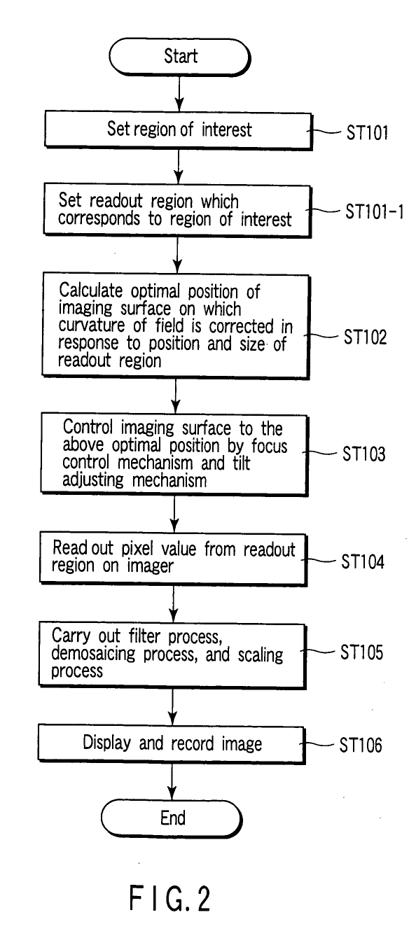

Now, an outline of an operation according to the embodiment will be described with reference to FIG. 2. First, in step ST101, a region of interest including a main object is set. Next, in step S101-1, a region in which image data to be read out from the imager 102 is set in response to the set region of interest. Next, in step ST102, an optimal position of an imaging surface on which curvature of field is corrected is calculated in response to the position and size of a readout region. In step ST103, based on the imaging surface bent data contained in the readout region, control is made so that the imaging surface arrives at the optimal position by the focus control mechanism 108 and the tilt adjusting mechanism 107 in a direction in which the curvature of field is corrected.

Then, in step ST104, a pixel value is read out from the readout region of the imager 102. Further, in step ST105, the pixel converting/recording/display unit 103 carries out a filter process, a demosaicing process, and a scaling process. In step ST106, the processed image is displayed and recorded.

Now, a detail on processing in the steps above will be described here. First, in step ST101, the user sets a region of interest which includes a main object. A description will be given with respect to a process for setting a readout region which corresponds to a region of interest in step ST101-1. There are several methods for executing this process. The most primitive method is such that the user specifies a frame of a region of interest on a display screen. Another method is such that a specified point is moved in parallel so as to bring the specified point to the substantial center of the screen; and, for example, as a specified time is extended, the range of a region to be read out is narrowed, the magnification is increased, and is stopped at the maximum telephoto point.

On the other hand, in a case where the main object almost overflows from a current screen due to the object approaching a camera, the user specifies the readout region to be broadened. In addition, when the user temporarily specifies the main object, the main object may be automatically tracked as long as the main object is within the viewing field of the camera. Alternatively, even if the user does not specify the object, a most interesting object in an image is estimated, whereby zoom-in may be carried out by an electronic zoom while the object is automatically tracked. An apex coordinate of the region of interest is determined by such a method.

Now, a description will be given with respect to a method for calculating an optimal position of an imaging surface on which curvature of field is corrected in response to the position and size of the readout region in step ST102. In this step, first, it is determined whether or not the readout region is out of a center of the imager 102, thereby selecting whether or not the imager 102 is tilted. The center of the imager 102 is defined as origin (0, 0), the upper left apex coordinate in the readout region is defined as (A, B), and the lower right apex coordinate is defined as (C, D). At this time, when the following condition is met, it is found that the readout region does not include an apex, namely, the region does not include the center position of the imager 102.

AC≧0 or BD≧0

For example, in a case where the readout region is not out of the center of the optical axis, as shown in FIG. 8A, AC>0, and BD<0 is established. Thus, although this condition is met, in the case where the readout region includes the center of the optical axis, as shown in FIG. 8B, AC<0, and BD<0 is established. Thus, this condition is not met.

When the condition is met, the tilt direction and tilt angle of the image 102 are calculated such that curvature of field can be corrected. The tilt direction used here denotes a direction such that a normal vector of the imager 102 is included in a plane which includes a vector and an optical axis which are oriented to a center of the readout region from the center of the imager 102. With respect to the tilt angle, for example, there is adopted an angle when a difference in readout region between a tilt of the imager 102 and a tilt of an optical imaging surface is minimized in terms of a least square approximation. As described above, the tilt direction and tilt angle of the imager 102 are calculated. An optimal focus position is calculated by a contrast in the readout region.

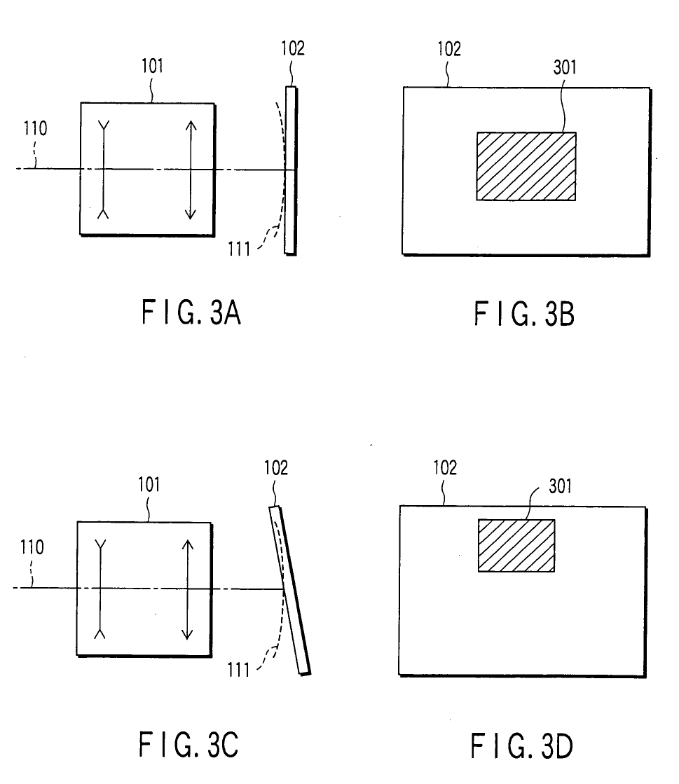

Hereinafter, with reference to FIGS. 3A to 3D, a description will be given with respect to procedures for tilting the imager 102 in response to a position of a readout region. First, as shown in FIG. 3B, in a case where a readout region 301 is at a substantial center of the image 102, the gravity of a position for focus control is placed at the center of an optical axis 110, and an imaging surface position is determined based on the contract of the center of the optical axis 110. In contrast, as shown in FIG. 3D, in the case where a readout region 302 is not out of the optical axis 110, a contrast calculating position which becomes a standard for focus control is set at a substantial center of the readout region 302. Even when the readout region is not out of the center of the imager 102, an image height also changes according to the size of the readout region, and concurrently, an optimal imaging surface position also changes. Thus, the imaging surface is relatively shifted to carry out adjustment of the imaging surface.

Further, in order to speed up the above processing operation, it is preferable that shift quantity, tilt direction and tilt angle be calculated in advance based on information of curvature of field which is already known at the time of optical design, and that the amount of data according to the position and size of the readout region be tabulated.

Now, a description will be given with respect to control of an imaging surface for an optimal position in step ST103. Here, a focus control mechanism 108 adjusts a focus position instead of shifting the imaging surface along an optical axis. Therefore, the calculated shift quantity is sent to the focus control mechanism 108, and the focus position is controlled. In addition, the calculated tilt direction and tilt angle are sent to control the focus position, and the calculated tilt direction and tilt angle are sent to the adjusting mechanism 107 to tilt the imager 102 in accordance with the tilt direction and tilt angle. FIG. 3B shows an appearance of the tilted imager.

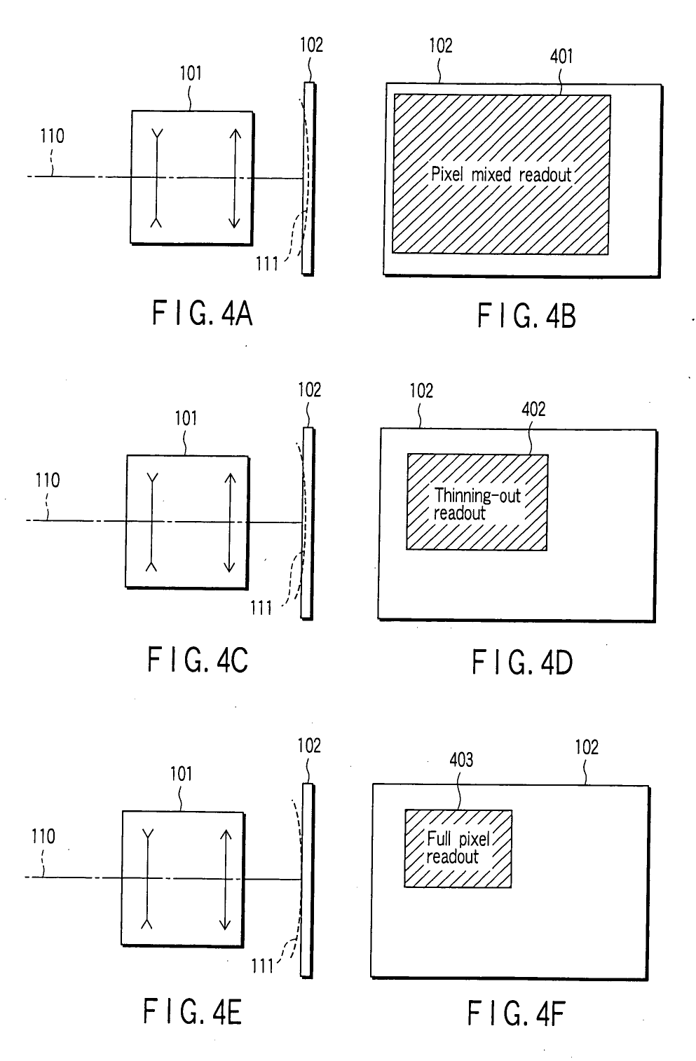

Now, a process for reading out a pixel in step ST04 will be described with reference to FIGS. 4A to 4F. FIGS. 4A and 4B each show an example of pixel mixed readout, FIGS. 4C and 4D each show an example of thinning-out readout, and FIGS. 4E and 4F each shows an example of full pixel readout. As pixel mixed readout, there is well-known additive readout for reading out while m (m≧2) pixels are added at the same time in one clock. An average value is calculated by dividing that value by “m”, and thus, this is also called averaging readout. In contrast, thinning-out readout is provided as a method for reading out “n” (m>n) pixels among “m” pixels. A high-speed scaling conversion can be achieved by carrying out such thinning-out readout.

Now, a description will be given with respect to a respective one of a demosaicing process, a filter process, and a scaling process in step ST105. First, the demosaicing process is also called a full coloring process. This process corresponds to a process for converting the image data received by a single-plate imager 102 to pixel data to be obtained in a three-plate imager 102 having demultiplexed and received each of wavelengths of R, G, and B by an interpolating process. Detail of the interpolating method are not given here.

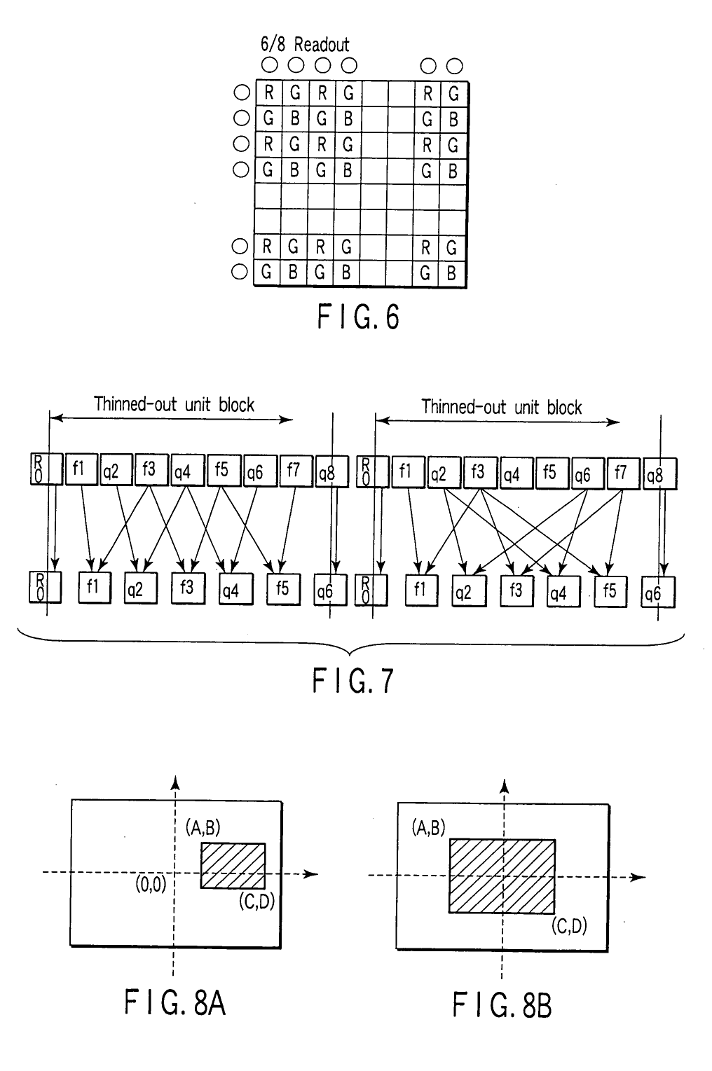

Now, a variety of processing operations are assumed for the filter process. As described above, although an image magnification can be electrically changed by carrying out thinning-out readout, distortions occur due to such thinning-out readout. Thus, a correcting process is carried out by a filter. FIG. 6 shows an example of readout by thinning out two pixels from eight pixels in both the horizontal direction and the vertical direction. If the readout as shown in FIG. 6 is carried out, an unnatural step occurs in an image, and geometrical distortions occur.

Therefore, as shown in FIG. 7A, an operation is made for defining the skipped pixels as eight pixel data by linear interpolation using the peripheral pixels, and then, thinning out the data so as to be six pixels by linear interpolation. This process converts the sampling at a non-uniform pixel interval to uniform sampling, as shown in FIG. 7B.

Lastly, a scaling process will be described here. At the time of readout, although a current magnification is converted to 1/m in the pixel mixed readout described previously, and is converted to n/m in the thinning-out readout, there is a limitation on combinations of values which can be taken by denominator “m” or numerator “n”. Thus, only a limited magnification can be achieved. Therefore, a scaling process is added to achieve an arbitrary magnification. For example, in achieving a reduction of 78%, first, a magnification conversion to 75% is made by means of thinning-out readout for reading out six pixels from eight pixels. Next, 75%×104%=78% can be obtained by combining a second scaling process using linear interpolation of 104%. As the second scaling process, a well-known process such as third interpolation can be used in addition to linear interpolation.

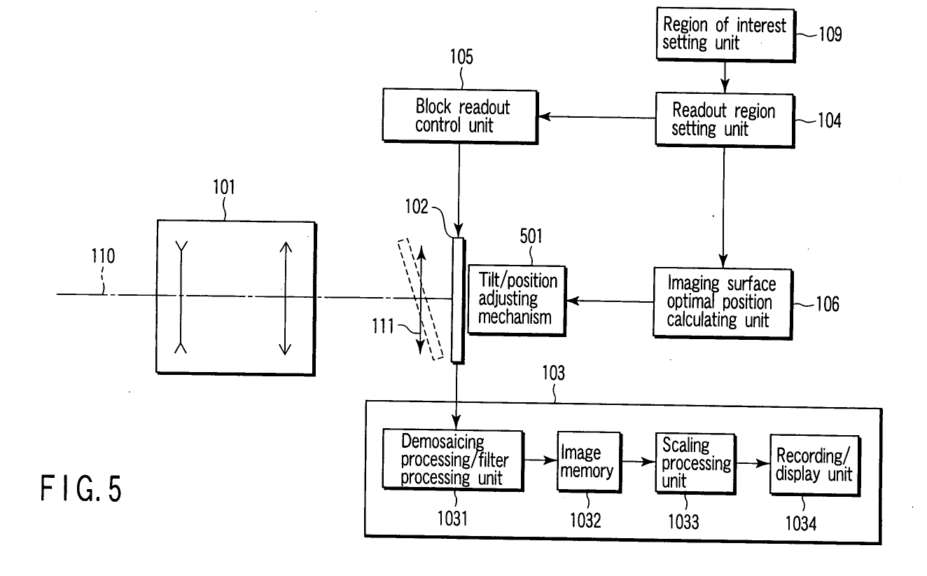

A description of the present embodiment is described above. Another embodiment will be briefly described with reference to FIG. 5. In FIG. 5, the focus control mechanism 108 shown in FIG. 1 is eliminated, and, instead of the tilt adjusting mechanism 107 which makes tilt control of the imager 102, a tilt and position adjusting mechanism 501 is provided for making shift control in an optical axis direction in order to move the imager 102 to a focus position as well as tilt control of the imager 102.

According to the above-described embodiment, in addition to zooming into a readout region including a main object by an electronic zoom with high resolution, an imaging surface is tilted so as to reduce effect caused by a curvature of field, in response to the position and size of the readout region on the imager 102 or shift a relative position of the imaging surface to an optical axis direction. Thus, there is attained the advantageous effect that geometrical distortion is reduced and that a clear magnified image which is well focused to the main object can be acquired at high resolution.

According to the present invention, in addition to zooming into a readout region including a main object by an electronic zoom with high resolution, an imaging surface is tilted so as to reduce effect caused by curvature of field or a relative position of the imaging surface is shifted in an optical axis direction. Thus, geometrical distortion is reduced and a clear magnified image which is well focused to the main object can be acquired at high resolution.

What is claimed is:

1. An imaging apparatus comprising:
an imaging device which acquires an object image as pixel data in accordance with photoelectric conversion;
a readout region setting unit which sets, from the imaging device, a region whose image data is read out;
a readout unit which reads out image data from the readout region;
an optimal position calculating unit which calculates an optimal position for imaging in response to a position and a size of the readout region set by the readout region setting unit; and
an adjusting mechanism which drives an imaging surface of the imaging device at an optimal position calculated by the optimal position calculating unit.

2. An imaging apparatus according to claim 1, wherein a total number of pixels for which readout is carried out by the readout unit is smaller than a total number of pixels configuring the imaging device.

3. An imaging apparatus according to claim 1, having a total pixel number changing unit which changes a total number of pixels for which readout is carried out by the readout unit.

4. An imaging apparatus according to claim 1, having a readout region changing unit which changes a size of the readout region.

5. An imaging apparatus according to claim 4, wherein the readout region changing unit comprises a pixel mixed readout function of reading out a plurality of pixels configuring the imaging device in one clock.

6. An imaging apparatus according to claim 4, wherein the readout region changing unit comprising a thinning-out readout function of reading out a plurality of pixels configuring the imaging device by thinning out the pixels.

7. An imaging apparatus according to claim 1, including an imaging device shifting mechanism which shifts the imaging surface by shifting a position of the imaging device relevant to an optical system which forms an image on the imaging device.

8. An imaging apparatus according to claim 1, including an optical element shifting mechanism which shifts the imaging surface by shifting an optical element which configures an optical system which forms an image on the imaging device.

9. An imaging apparatus according to claim 1, further comprising an object tracking mechanism which tracks a main object, wherein the block readout unit carries out readout by referring to positional information on the object acquired by the object tracking mechanism.

10. An imaging apparatus comprising:
an imaging device which acquires an object image as pixel data in accordance with photoelectric conversion;
a region of interest setting unit which sets a region of interest which includes a main object in an image acquired by the imaging device;
a readout region setting unit which sets a region in which image data is to be read out from the imaging device in response to the region of interest set by the region of interest setting unit;
a readout unit which reads out image data from the readout region;
a recording/display unit which records or displays the read out image data after converted to a mode suitable to an output;
an optimal position calculating unit which calculates an optimal position which is optimal for imaging according to a position and a size of the readout region set by the readout region setting unit; and
an adjusting mechanism which drives an imaging surface of the imaging device at the optimal position calculated by the optimal position calculating unit.

11. An imaging apparatus according to claim 10, wherein a total number of pixels for which readout is carried out by the readout unit is smaller than a total number of pixels configuring the imaging device.

12. An imaging apparatus according to claim 10, having a total pixel number changing unit which changes a total number of pixels for which readout is carried out by the readout unit.

13. An imaging apparatus according to claim 10, having a readout region changing unit which changes a size of the readout region.

14. An imaging apparatus according to claim 13, wherein the readout region changing unit comprises a pixel mixed readout function of reading out a plurality of pixels configuring the imaging device in one clock.

15. An imaging apparatus according to claim 13, wherein the readout region changing unit comprises a thinning-out readout function of reading out a plurality of pixels configuring the imaging device by thinning out the pixels.

16. An imaging apparatus according to claim 10, including an imaging device shift mechanism which shifts the imaging surface by shifting a position of the imaging device relevant to an optical system which forms an image on the imaging device.

17. An imaging apparatus according to claim 10, including an optical element shifting mechanism which shifts the imaging surface by shifting an optical element which configures an optical system which forms an image on the imaging device.

18. An imaging apparatus according to claim 10, further comprising an object tracking mechanism which tracks a main object, wherein the block readout unit carries out readout by referring to positional information on the object acquired by the object tracking mechanism.
